(19) United States
(12) Patent Application Publication
(10) Pub. No.: US 2008/0210495 A1
(43) Pub. Date: Sep. 4, 2008

(54) Removable Corrosion Protection on an Elevator Guide Rail

(76) Inventor: Richard N. Fargo, Plainville, CT (US)

Correspondence Address: CARLSON GASKEY & OLDS, 400 W MAPLE STE 350, BIRMINGHAM, MI, 48009, US

(21) Appl. No.: 11/911,992

(22) PCT Filed: Apr. 20, 2005
(86) PCT No.: PCT/US05/13875

§ 371 Date: Oct. 19, 2007

(51) Int. Cl. B66B 7/02

(52) U.S. Cl. 187/406

(57) ABSTRACT

A guide rail for an elevator system includes a plastic layer covering over at least guiding surfaces of a blade portion. The plastic layer is applied to protect selected surfaces during shipment and storage, for example. At an appropriate time during installation, the plastic layer is removable to expose the protected guiding surfaces.

### 1. FIELD OF THE INVENTION

This invention generally relates to elevator systems. More particularly, this invention relates to guide rails for elevator systems.

### 2. DESCRIPTION OF THE RELATED ART

Elevator systems typically include a set of guide rails for guiding an elevator car as it moves vertically within a hoistway, for example. Typical guide rails have a generally T-shaped cross-section with a base portion that is secured against a hoistway wall using conventional brackets. A blade portion extending away from the base portion provides guiding surfaces along which guide rollers or slides travel during elevator car movement.

The blade portion of a guide rail also provides a surface that elevator safeties engage during over speed conditions, for example.

The functions of the surfaces on the blade portion of a guide rail require the surfaces to be within acceptable standards. Most guide rails are made from steel and the surfaces must be protected from corrosion during storage and shipment, for example. The base portion of a guide rail typically is painted to prevent it from corroding. The blade surfaces, however, cannot be painted because of the potential for the paint to interfere with operation of the elevator safeties.

It is necessary to ensure that the blade portions of guide rails are protected from corrosion during shipment or storage and that they are in an appropriate condition at the time of installation. The typical way of protecting the blade portion of a guide rail from corrosion includes applying an anti-corrosion coating that must be removed at the installation site using a chemical solvent. There are various disadvantages associated with this technique. For example, the typical job site during the construction phase of installing an elevator system does not lend itself to reliably, consistently or thoroughly cleaning off the anti-corrosion coating. These issues sometimes become further complicated in that there is not a consistent application of the corrosion inhibitor and there is not necessarily a consistent cleaning process. The labor and expense involved in removing the coating introduces additional cost for installing an elevator system. There are additional material costs for acquiring the appropriate solvents and cleaning materials.

There is a need for an improved arrangement for protecting guide rails from corrosion and preparing at least the blade portion surfaces for use at the installation site. This invention addresses that need.

### SUMMARY OF THE INVENTION

An exemplary disclosed guide rail includes a removable plastic layer that covers at least a selected surface on the guide rail.

In one example, the rail body has a blade portion and a plastic layer coves at least the blade portion. In one example, the plastic layer comprises a sheet of plastic material that can be peeled off to expose the blade surfaces that have been protected from corrosion by the plastic layer.

An example method of protecting a guide rail from corrosion includes covering at least a selected surface on the guide rail with a removable plastic layer.

In one example, a sheet of plastic material is adhesively secured to the selected surfaces on the guide rail. The adhesive used in one example allows the material to be peeled off without leaving any consequential residue on the guide rail surfaces.

An exemplary disclosed method of installation a guide rail in an elevator system includes peeling a plastic layer from at least a selected surface of the guide rail.

The various features and advantages of this invention will become apparent to those skilled in the art from the following detailed description of a currently preferred embodiment. The drawings that accompany the detailed description can be briefly described as follows.

### BRIEF DESCRIPTION OF THE DRAWINGS

FIG. 1 schematically illustrates selected portions of an elevator system.

FIG. 2 schematically shows selected features of an example guide rail.

FIG. 3 schematically shows a selected portion of an example guide rail during a portion of an installation process.

### DETAILED DESCRIPTION OF THE PREFERRED EMBODIMENTS

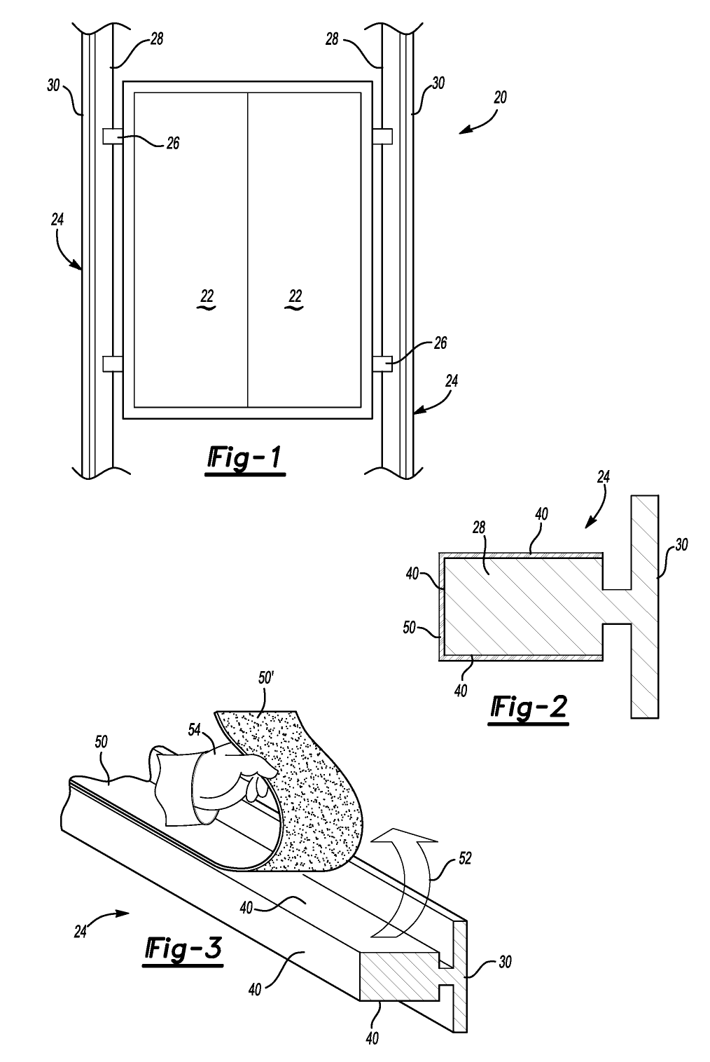

FIG. 1 schematically shows selected portions of an elevator system 20. An elevator car 22 is guided along guide rails 24 through the operation of guiding devices 26. In one example, the guiding devices 26 include guide rollers that operate in a known manner. Other example guiding devices include slides that operate as known.

As best appreciated from FIGS. 1 and 2, the guide rails 24 each include a blade portion 28 along which the guiding devices 26 travel during elevator car movement. A base portion 30 facilitates mounting the guide rails within a hoistway using known brackets, for example.

In the illustrated example, the blade portion 28 has three guiding surfaces 40 along which the guiding devices 26 travel. At least two of the guiding surfaces 40 also provide a braking surface for elevator safeties to engage during an over speed condition, for example.

As shown in FIG. 2, at least the blade portion 28 of the guide rail 24 is covered with a removable plastic layer 50. In one example, the plastic layer includes a known corrosion inhibitor. Covering at least the guiding surfaces 40 of the blade portion 28 protects those surfaces from corrosion during shipment or storage of the guide rails 24, for example. The plastic layer 50 is removable at a convenient time associated with installing the guide rails at an appropriate location.

In one example, the plastic layer comprises a sheet or film of plastic material that is adhesively secured to the corresponding surface or surfaces of the guide rail 24. An adhesive side 50′ of the example film allows easy removal of the plastic layer 50. FIG. 3 schematically shows an example process of removing at least a portion of the plastic layer 50 by manually peeling it off of the guide rail. In FIG. 3, this peeling motion is schematically shown by the arrow 52 and can be accomplished using an individual's hand 54, for example. In this example, the adhesive clings to the plastic layer 50 upon peeling and does not leave any consequential residue on the guide rail.

Some plastic materials may be applied in a liquid form by spraying, brushing or pouring the liquid onto the guide rail. Once the material cures, it results in a protective plastic layer.

One example plastic material that is useful for corrosion protection is the commercially available MCI® Peel-off Coating, which is a corrosion inhibiting modified water-based acrylic peelable coating available from Cortec Corporation. Another example, which is a plastic film, is the VCI PE stretch cling film available from Modi Polymers Pvt Ltd. A variety of such materials are known and those skilled in the art who have the benefit of this description will be able to select an appropriate material to meet the needs of their particular situation.

In one example, a single sheet of plastic material covers over all the guiding surfaces 40 on the example blade portion. In another example, an individual sheet of the plastic material is used for each of the guiding surfaces 40. Depending on the materials selected and the technique for applying the layer to the guiding surfaces, a number of variations are possible.

In one example, the base portion 30 is painted to protect it from corrosion. The plastic layer 50 is applied to the blade portion 28 first and serves as a mask to prevent paint from getting on the blade portion guiding surfaces 40, which cannot be painted. This example includes the added benefit of covering and masking the guiding surfaces 40 to facilitate painting the base portion.

The disclosed examples provide an improved protection against corrosion for guide rails that are useful in elevator systems. With the disclosed arrangement, the process of removing a corrosion protection is simplified, more reliable and, in at least some examples, more economical.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1-20. (canceled)

21. A guide rail for use in an elevator system, comprising:
a peelable corrosion inhibiting material covering at least a selected surface on the guide rail.

22. The guide rail of claim 21, wherein the peelable corrosion inhibiting material comprises a layer secured directly to at least the selected surface.

23. The guide rail of claim 22, wherein the guide rail has a blade portion and the layer covers at least the blade portion.

24. The guide rail of claim 23, wherein the layer comprises a sheet of the corrosion inhibiting material covering over the entire blade portion.

25. The guide rail of claim 21, wherein the peelable corrosion inhibiting material comprises at least one sheet.

26. The guide rail of claim 25, including an adhesive that secures the sheet to the selected surface.

27. The guide rail of claim 21, wherein the peelable corrosion inhibiting material comprises plastic.

28. The guide rail of claim 21, wherein the peelable corrosion inhibiting material comprises a film.

29. The guide rail of claim 28, wherein the film comprises a cured, liquid material applied to at least the selected surface.

30. A method of protecting an elevator system guide rail from corrosion, comprising:
covering at least a selected surface on the guide rail with a peelable corrosion inhibiting material.

31. The method of claim 30, including covering a blade portion of the guide rail with the peelable corrosion inhibiting material.

32. The method of claim 31, including covering other portions of the guide rail with another material.

33. The method of claim 32, including painting the other portions of the guide rail.

34. The method of claim 32, including using the peelable corrosion inhibiting material as a mask for protecting the blade portion from the other material when covering the other portions of the guide rail with the other material.

35. The method of claim 30, including adhesively securing a layer of the corrosion inhibiting material to at least the selected surface.

36. The method of claim 30, including applying at least one sheet of the corrosion inhibiting material to at least the selected surface.

37. The method of claim 30, including applying the peelable corrosion inhibiting material in a liquid form.

38. The method of claim 37, wherein the applying comprises at least one of spraying, brushing or pouring on the corrosion inhibiting material.

39. The method of claim 30, wherein the peelable corrosion inhibiting material comprises plastic.

40. A method of installing a guide rail in an elevator system, comprising:
peeling a corrosion inhibiting material from at least a selected surface of the guide rail.

41. The method of claim 40, including manually peeling the corrosion inhibiting material from at least the selected surface of the guide rail.
